(19) United States
(12) Patent Application Publication
(10) Pub. No.: US 2025/0297951 A1
(43) Pub. Date: Sep. 25, 2025

(54) GAS DETECTION DEVICE AND CONTROL METHOD FOR GAS DETECTION DEVICE

(71) Applicant: Kabushiki Kaisha Toshiba, Tokyo (JP)

(72) Inventors: Masatoshi HIRONO, Yokohama Kanagawa (JP); Shinji SAITO, Yokohama Kanagawa (JP); Rei HASHIMOTO, Edogawa Tokyo (JP); Tsutomu KAKUNO, Fujisawa Kanagawa (JP); Tetsuya MIYAGAWA, Yokohama Kanagawa (JP); Kei KANEKO, Yokohama Kanagawa (JP); Shinji OOKUMA, Yokohama Kanagawa (JP)

(21) Appl. No.: 18/768,703

(22) Filed: Jul. 10, 2024

(30) Foreign Application Priority Data
Mar. 22, 2024 (JP) 2024-046031

(51) Int. Cl. G01N 21/3504

(52) U.S. Cl. CPC G01N 21/3504; G01N 2201/06113; G01N 2201/0668; G01N 2201/0691

(57) ABSTRACT

According to one embodiment, a gas detection device includes a driver section, an element section, a sensor, and a detector. The driver section includes a first driver and a second driver. The element section includes a first laser and a second laser. The first laser is configured to be driven by the first driver to emit a first beam. A first wavelength of the first beam is configured to change at a first frequency. The second laser is configured to be driven by the second driver to emit a second beam. A second wavelength of the second beam is configured to change at a second frequency. The second frequency is different from the first frequency. The second wavelength is different from the first wavelength. The sensor is configured to detect a received beam based on the first beam and the second beam.

### CROSS-REFERENCE TO RELATED APPLICATIONS

This application is based upon and claims the benefit of priority from Japanese Patent Application No. 2024-046031, filed on Mar. 22, 2024; the entire contents of which are incorporated herein by reference.

### FIELD

Embodiments described herein relate generally to a gas detection device and a control method for gas detection device

### BACKGROUND

For example, there is a gas detection device that detects a detection target based on laser absorption by the detection target. Downsizing of gas detection devices is desired.

### BRIEF DESCRIPTION OF THE DRAWINGS

FIG. 1 is a schematic diagram illustrating a gas detection device according to a first embodiment;

FIG. 2 is a schematic diagram illustrating the gas detection device according to the first embodiment; and

FIG. 3 is a flowchart illustrating a method of controlling the gas detection device according to a second embodiment.

### DETAILED DESCRIPTION

According to one embodiment, a gas detection device includes a driver section, an element section, a sensor, and a detector. The driver section includes a first driver and a second driver. The element section includes a first laser and a second laser. The first laser is configured to be driven by the first driver to emit a first beam. A first wavelength of the first beam is configured to change at a first frequency. The second laser is configured to be driven by the second driver to emit a second beam. A second wavelength of the second beam is configured to change at a second frequency. The second frequency is different from the first frequency. The second wavelength is different from the first wavelength. The sensor is configured to detect a received beam based on the first beam and the second beam. The detector configured to extract a target frequency component from an output signal from the sensor.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

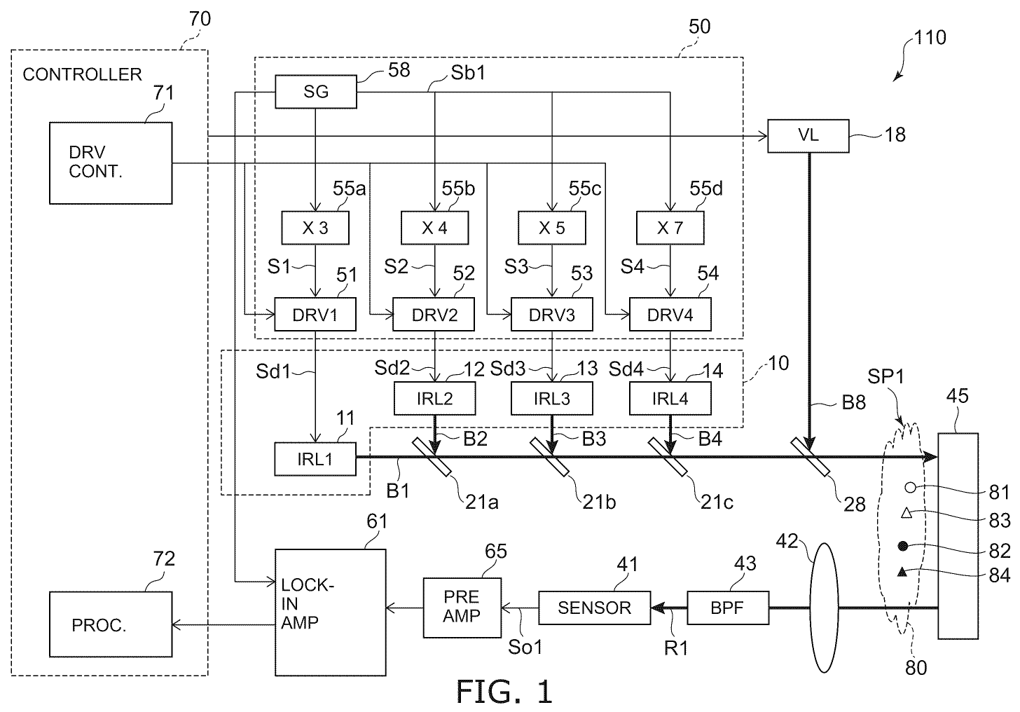

FIG. 1 is a schematic diagram illustrating a gas detection device according to a first embodiment.

As shown in FIG. 1, a gas detection device 110 according to the embodiment includes a driver section 50, an element section 10, a sensor 41, and a detector 61.

The driver section 50 includes a first driver 51 and a second driver 52. As described later, the driver section 50 may further include other drivers (for example, a third driver 53 and a fourth driver 54).

The element section 10 includes a first laser 11 and a second laser 12. As described later, the element section 10 may further include other lasers (for example, a third laser 13 and a fourth laser 14).

The first laser 11 is configured to be driven by the first driver 51 and emit a first beam B1. A wavelength of the first beam B1 (first wavelength) changes at a first frequency f1. For example, a first drive signal Sd1 is supplied from the first driver 51 to the first laser 11. The first wavelength is modulated by the first drive signal Sd1.

The second laser 12 is configured to be driven by the second driver 52 and emit a second beam B2. A wavelength of the second beam B2 (second wavelength) changes at a second frequency f2. For example, the second drive signal Sd2 is supplied from the second driver 52 to the second laser 12. The second wavelength is modulated by the second drive signal Sd2. The second frequency f2 is different from the first frequency f1. The second wavelength (wavelength band) is different from the first wavelength (wavelength band).

The sensor 41 detects a received beam R1 based on the first beam B1 and the second beam B2. The sensor 41 outputs an output signal So1 according to the received beam R1. The detector 61 is configured to extract a target frequency component from an output signal So1 from the sensor 41.

In the example shown in FIG. 1, the first beam B1 and the second beam B2 pass through the space SP1 on the path of the first beam B1 and the second beam B2. In this example, these beams are reflected by the reflector 45 and reach the sensor 41 as the received beam R1. A detection target 80 exists in space

SP1. The detection target 80 may be, for example, gas. The detection target 80 includes molecules or elements such as methane, dinitrogen monoxide, and carbon dioxide. The detection target 80 has a unique absorption wavelength. By evaluating the intensity of the received beam R1 detected by the sensor 41, the presence or absence of the detection target 80 and/or the concentration of the detection target 80 can be detected. The detection target 80 may include a plurality of substances of different types (a first detection target 81, a second detection target 82, etc.).

In the embodiment, the beam emitted by the laser is modulated at a particular frequency. A frequency component corresponding to the modulation frequency is extracted by the detector 61, and the intensity of the extracted signal is detected. In the embodiment, a plurality of laser beams (first beam B1, second beam B2, etc.) having mutually different wavelengths are detected by one sensor 41. The received beam R1 received by the sensor 41 includes different wavelength components. The output signal So1 corresponding to the received beam R1 is extracted by the detector 61 as the target frequency component.

Thereby, a plurality of types of detection targets 80 can be detected with high accuracy by the single sensor 41.

For example, a reference example may be considered in which a first sensor is provided corresponding to the first laser 11 and a second sensor is provided corresponding to the second laser 12. In this reference example, the number of sensors increases. Thereby, there is a limit to downsizing the device.

In contrast, in the embodiment, the single sensor 41 is provided for a plurality of lasers that emit beams of different wavelengths. The number of sensors 41 may be one. According to the embodiment, it is possible to provide a gas detection device that can be downsized. According to the embodiment, costs can be reduced. According to the embodiment, it is possible to provide a gas detection device that can reduce power consumption.

The first wavelength of the first beam B1 is modulated at the first frequency f1 around a first intermediate wavelength. For example, the first wavelength changes between a first short wavelength and a first long wavelength at the first frequency f1. The first long wavelength is longer than the first short wavelength. The first intermediate wavelength exists between the first long wavelength and the first short wavelength. For example, the first intermediate wavelength corresponds to absorption the wavelength of the first detection target 81 (first substance). The intensity of the first intermediate wavelength changes depending on the presence or absence of the first detection target 81. The wavelength of the first beam B1 to be modulated becomes the first intermediate wavelength twice during one period. Information regarding the presence or absence (and concentration) of the first detection target 81 can be obtained by detecting a change in the frequency component twice the first frequency f1. Based on this information, the first detection target 81 can be detected.

For example, a first intensity of the output signal So1 in a first state is lower than a second intensity of the output signal So1 in a second state. A concentration of the first detection target 81 (first gas, etc.) existing on the path of the first beam B1 in the first state is higher than a second concentration of the first detection target 81 existing on the path in the second state. The first state is a high concentration state. The second state is a low concentration state (or non-existent state). In such a case, the signal strength in the first state becomes lower than the signal strength in the second state because the beam is absorbed.

For example, the detector 61 may be configured to extract a component (first component) of the output signal So1 having a frequency twice the first frequency f1. The first component changes according to the state of the first detection target 81 present on the path (first path) of the first beam B1. The component of the frequency twice the first frequency f1 in the first state of the high concentration state is higher than the component of the frequency twice the first frequency f1 in the 25 second state of the low concentration state.

For example, the detector 61 may be configured to extract a component (second component) of the output signal So1 having a frequency twice the second frequency f2. The second component changes according to the state of the second detection target 82 present on the path (second path) of the second beam B2. The component of the frequency twice the second frequency f2 in a third state of the high concentration state is higher than the component of the frequency twice the second frequency f2 in a fourth state of the low concentration state. The concentration of the second detection target 82 (such as the second gas) present on the path of the second beam B2 in the third state is higher than the fourth concentration of the second detection target 82 present on the path in the fourth state.

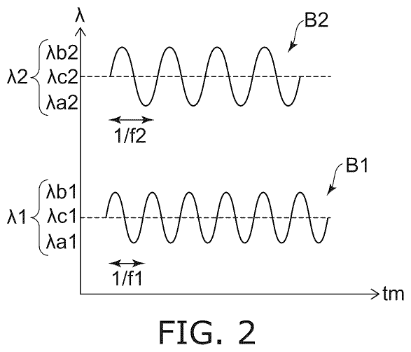

FIG. 2 is a schematic diagram illustrating the gas detection device according to the first embodiment.

FIG. 2 illustrates the first beam B1 and the second beam B2. The horizontal axis in FIG. 2 is time tm. The vertical axis is the beam wavelength λ.

As shown in FIG. 2, the first wavelength λ1 of the first beam B1 changes at the first frequency f1 between the first short wavelength λa1 and the first long wavelength λb1. The first long wavelength λb1 is longer than the first short wavelength λa1. The first intermediate wavelength λc1 exists between the first short wavelength λa1 and the first long wavelength λb1.

As shown in FIG. 2, the second wavelength λ2 of the second beam B2 changes at the second frequency f2 between the second short wavelength λa2 and the second long wavelength λb2. The second long wavelength λb2 is longer than the second short wavelength λa2. The second intermediate wavelength λc2 exists between the second short wavelength λa2 and the second long wavelength λb2.

In one example, the second short wavelength λa2 is longer than the first long wavelength λb1. Alternatively, in the embodiment, the second long wavelength λb2 is shorter than the first short wavelength λa1. In one example, the wavelengths of the first beam B1 and the second beam B2 do not substantially overlap. Thereby, the first detection target 81 can be detected with higher accuracy by the first beam B1. The second detection target 82 can be detected with higher accuracy by the second beam B2.

In the embodiment, the first beam B1 and the second beam B2 include near-infrared rays, mid-infrared rays, or far-infrared rays. The detection target 80 can be detected with high accuracy.

For example, the first wavelength λ1 may be not less than 4.4 μm and not more than 4.7 μm. The second wavelength λ2 may be not less than 7.6 μm and not more than 7.9 μm.

As shown in FIG. 1, in the embodiment, the driver section 50 may include a signal generator 58. The signal generator 58 is configured to output a base signal Sb1 having a base frequency f0. The drive signal may be controlled based on the base signal Sb1. The operation of the detector 61 may be controlled based on the base signal Sb1.

As shown in FIG. 1, in the embodiment, the driver section 50 may include a first multiplier 55a and a second multiplier 55b. The first multiplier 55a is configured to supply the first driver 51 with a first signal S1 having a frequency that is a first integer multiple of the base frequency f0 based on the base signal Sb1. The first driver 51 supplies the first laser 11 with the first drive signal Sd1 based on the first signal S1.

The second multiplier 55b is configured to supply the second driver 52 with a second signal S2 having a frequency that is a second integer multiple of the base frequency f0 based on the base signal Sb1. The second driver 52 supplies the second laser 12 with the second drive signal Sd2 based on the second signal S2. The second integer is different from the first integer. In this example, the first integer is 3. The second integer is 4. By using the base frequency f0 as a reference, the first laser 11 and the second laser 12 can be controlled with high precision.

In the embodiment, the second frequency f2 may be different from an integer multiple of twice the first frequency f1. The first frequency f1 may be different from an integer multiple of twice the second frequency f2. Since the harmonics do not overlap, the output signal So1 can be effectively separated.

In the embodiment, at least a part of the second period in which the second beam B2 is emitted may overlap the first period in which the first beam B1 is emitted. These beams may be emitted temporally overlapping each other. Detection with high accuracy is possible in a short time.

For example, a reference example may be considered in which beams of different wavelengths are emitted at different timings. In this reference example, the emission time of one beam per unit time is shortened. The beam intensity detection becomes low and it is difficult to obtain high accuracy. Alternatively, if sufficient intensity is obtained, the detection time becomes longer.

On the other hand, in the embodiment, at least a part of the plurality of beams having different wavelengths are emitted while temporally overlapping. Highly accurate detection is possible in a short time.

At least a part of the second beam B2 may spatially overlap with the first beam B1. For example, even when the size of the sensor 41 is small, the received beam R1 can be efficiently incident on the sensor 41. For example, high spatial resolution can be obtained.

As shown in FIG. 1, the gas detection device 110 may further include a first optical element 21a. The first optical element 21a overlaps the second beam B2 with the first beam B1. In one example, the first optical element 21a may be a low pass filter.

The received beam R1 may include reflected beams of the first beam B1 and the second beam B2. As shown in FIG. 1, the first beam B1 and the second beam B2 may be reflected by the reflector 45 to become the received beam R1. The reflector 45 is, for example, a retroreflector. The detection becomes easier. The gas detection device 110 may include the reflector 45. The reflector 45 may be provided separately from the gas detection device 110. In the embodiment, the sensor 41 may detect the first beam B1 and the second beam B2 that have passed through the space SP1 as the received beam R1.

As shown in FIG. 1, the gas detection device 110 may include a focus element 42. The focus element 42 collects the beams (first beam B1, second beam B2, etc.) that have traveled through the space SP1. Efficient detection becomes possible.

As shown in FIG. 1, the gas detection device 110 may include a bandpass filter 43. The bandpass filter 43 transmits a part of the beam that has passed through the focus element 42 and attenuates other part. Unwanted signals are removed, making highly accurate detection easier. The beam that has passed through the bandpass filter 43 is incident on the sensor 41.

As shown in FIG. 1, the gas detection device 110 may include a preamplifier 65. Preamplifier 65 amplifies the output signal So1 from sensor 41. The output signal So1 being amplified is supplied to the detector 61.

In one example, the detector 61 may include a lock-in amplifier. For example, as shown in FIG. 1, the base signal Sb1 having the base frequency f0 (or a signal corresponding to the base signal Sb1) is supplied from the signal generator 58 to the detector 61 as a reference signal. In the detector 61, a target signal component is extracted using the base frequency f0 or a frequency corresponding to the base frequency f0. The extracted signal component becomes the detection result of the detection target 80.

As shown in FIG. 1, the gas detection device 110 may include a controller 70. The controller 70 may include a processor 72, for example. The processor 72 is configured to process the signal obtained from the detector 61 (signal corresponding to the detection result). For example, the processor 72 may compare the signal obtained from the detector 61 with a reference value to determine the presence or absence of the detection target 80 (gas). The determination result may be output.

The controller 70 may include a driver controller 71. The driver controller 71 is configured to control a plurality of drivers (such as the first driver 51 and the second driver 52). For example, the first driver 51 supplies the first drive signal Sd1 to the first laser 11 based on the output of the first multiplier 55a and the control of the driver controller 71. For example, the second driver 52 supplies the second drive signal Sd2 to the second laser 12 based on the output of the second multiplier 55b and the control of the driver controller 71.

As shown in FIG. 1, the gas detection device 110 may further include a visible light laser 18. The visible light laser 18 emits a visible light beam B8. For example, the visible light beam B8 is emitted toward the space SP1 together with the first beam B1 and the second beam B2. The visible light beam B8 is used, for example, as a target laser.

As shown in FIG. 1, the driver section 50 may further include a third driver 53. The element section 10 may further include a third laser 13. The third laser 13 is configured to be driven by the third driver 53 and emit a third beam B3. The third wavelength of the third beam B3 changes at a third frequency f3. The third wavelength is different from the first wavelength λ1 and different from the second wavelength λ2. The third frequency f3 is different from the first frequency f1 and different from the second frequency f2. The received beam R1 is further based on the third beam B3. The detector 61 is configured, for example, to further extract a third component of the output signal So1 having a frequency twice the third frequency f3.

As shown in FIG. 1, the gas detection device 110 may further include a second optical element 21b. The second optical element 21b overlaps the third beam B3 with the first beam B1. In one example, the second optical element 21b may be a low pass filter.

As already explained, the first multiplier 55a is configured to supply the first driver 51 with the first signal S1 having a frequency that is a first integer multiple of the base frequency f0 based on the base signal Sb1. The second multiplier 55b is configured to supply the second driver 52 with the second signal S2 having a frequency that is a second integer multiple of the base frequency f0 based on the base signal Sb1.

As shown in FIG. 1, the driver section 50 may further include a third multiplier 55c. The third multiplier 55c is configured to supply the third driver 53 with a third signal S3 having a frequency that is a third integer multiple of the base frequency f0 based on the base signal Sb1. The second integer is different from the first integer. The third integer is different from the first integer and different from the second integer. In this example, the first integer is 3. The second integer is 4. The third integer is a prime number greater than or equal to 5. The third integer may be 5.

The first driver 51 supplies the first laser 11 with the first drive signal Sd1 based on the first signal S1. The second driver 52 supplies the second laser 12 with the second drive signal Sd2 based on the second signal S2. The third driver 53 supplies the third laser 13 with the third drive signal Sd3 based on the third signal S3. A third detection target 83 is detected by the third beam B3 of the third laser 13.

As shown in FIG. 1, the driver section 50 may further include the fourth driver 54. The element section 10 may further include the fourth laser 14. The fourth laser 14 is configured to be driven by the fourth driver 54 and emit a fourth beam B4. A fourth wavelength of the fourth beam B4 changes at a fourth frequency f4. The fourth wavelength is different from the first wavelength λ1, different from the second wavelength λ2, and different from the third wavelength. The fourth frequency f4 is different from the first frequency f1, different from the second frequency f2, and different from the third frequency f3. The received beam R1 is further based on the fourth beam B4. The detector 61 is configured, for example, to further extract a fourth component of the output signal So1 having a frequency twice the fourth frequency f4. A fourth detection target 84 can be detected by the fourth beam B4.

As shown in FIG. 1, the gas detection device 110 may further include a third optical element 21c. The third optical element 21c overlaps the fourth beam B4 with the first beam B1. In one example, the third optical element 21c may be a low pass filter.

As shown in FIG. 1, the driver section 50 may further include a fourth multiplier 55d. The fourth multiplier 55d is configured to supply the fourth driver 54 with a fourth signal S4 having a frequency that is a fourth integer multiple of the base frequency f0 based on the base signal Sb1. The fourth driver 54 supplies the fourth laser 14 with a fourth drive signal Sd4 based on the fourth signal S4. The fourth integer is different from the first integer, different from the second integer, and different from the third integer. For example, the first integer may be 3, the second integer may be 4, the third integer may be 5, and the fourth integer may be 7.

In the embodiment, the laser included in the element section 10 may be, for example, a quantum cascade laser (QCL). For example, at least one of the first laser 11, second laser 12, third laser 13, and fourth laser 14 may be a QCL. The laser included in the element section 10 may include, for example, a photonic crystal layer. The laser included in the element section 10 may be of a surface emitting type, for example. The laser included in the element section 10 may be of an edge emitting type, for example.

### Second Embodiment

The second embodiment relates to a method of controlling the gas detection device 110.

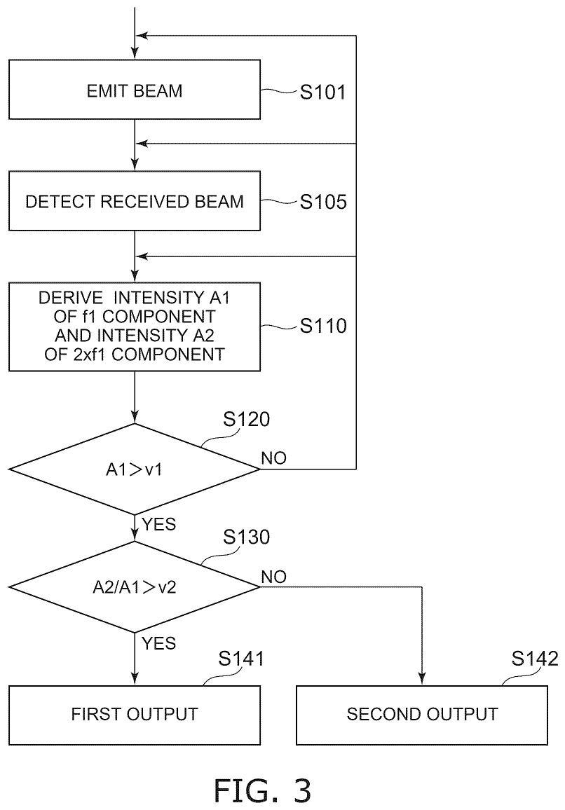

FIG. 3 is a flowchart illustrating a method of controlling the gas detection device according to the second embodiment.

As shown in FIG. 3, for example, the element section 10 is caused to emit laser beams (for example, the first beam B1 and the second beam B2) (step S101). For example, the received beam R1 is detected (step S105). Step S105 is performed by the sensor 41, for example.

As shown in FIG. 3, from the detection result of the received beam R1, a first intensity A1 of the component of the first frequency f1 and a second intensity A2 of the component of the frequency twice the first frequency f1 are derived (step S110). Step S110 is performed by the detector 61 and the processor 72, for example.

As shown in FIG. 3, the first intensity A1 is compared with a first reference value v1 (step S120). When the first intensity A1 is higher than the first reference value v1, the process moves to step S130. In step S130, the ratio of the second intensity A2 to the first intensity A1 is compared with a second reference value v2. If the ratio is higher than the second reference value v2, a first output is output (step S141).

The first output may be, for example, information corresponding to a ratio of the second intensity A2 to the first intensity A1. The first output may be, for example, information indicating that the ratio is higher than the second reference value v2. The first output may be, for example, information indicating that the first detection target 81 exists.

If the ratio is less than or equal to the second reference value v2 in step S130, the first output is not output. For example, if the ratio is less than or equal to the second reference value v2, a second output is output (step S142). The second output may be, for example, information indicating that the ratio is less than or equal to the second reference value v2. The second output may be, for example, information indicating that the first detection target 81 does not exist.

In step S120 above, if the first intensity A1 is less than or equal to the first reference value v1, the process may return to step S110, step S105, or step S101, for example. In this case, for example, in step S101, at least one of the plurality of lasers may be stopped and the other lasers may be operated. In this state, measurements (step S105 and subsequent steps) may be performed.

In step S120 above, if the first intensity A1 is less than or equal to the first reference value v1, the operation of the visible light laser 18 may be stopped and the other lasers may be operated. Measurement (step S105 and subsequent steps) may be performed in this state.

As described above, when the first intensity A1 of the component of the first frequency f1 of the output signal So1 is higher than the first reference value v1, the gas detection device 110 is caused to execute the first operation. The first operation includes outputting a value corresponding to the ratio of the second intensity A2 of a component of the output signal So1 having a frequency twice the first frequency f1 to the first intensity A1. This value may be, for example, the ratio of the second intensity A2 to the first intensity A1. The first operation includes, for example, outputting the first output. A highly accurate measurement can be performed.

In the control method according to the embodiment, when the first intensity A1 is equal to or less than the first reference value v1, the gas detection device 110 is not caused to execute the first operation. For example, as described above, the measurement (step S105 and subsequent steps) may be performed again in a state where at least one of the plurality of lasers is stopped. For example, as described above, the operation of the visible light laser 18 may be stopped, and the measurement (step S105 and subsequent steps) may be performed again. A highly accurate measurement can be performed.

The embodiments may include the following Technical proposals:

### Technical Proposal 1

A gas detection device, comprising:
a driver section including a first driver and a second driver;
an element section including a first laser and a second laser, the first laser being configured to be driven by the first driver to emit a first beam, a first wavelength of the first beam being configured to change at a first frequency, the second laser being configured to be driven by the second driver to emit a second beam, a second wavelength of the second beam being configured to change at a second frequency, the second frequency being different from the first frequency, the second wavelength being different from the first wavelength;
a sensor configured to detect a received beam based on the first beam and the second beam; and
a detector configured to extract a target frequency component from an output signal from the sensor.

### Technical Proposal 2

The gas detection device according to Technical proposal 1, wherein
the first wavelength is configured to change at the first frequency between a first short wavelength and a first long wavelength,
the first long wavelength is longer than the first short wavelength,
the second wavelength is configured to change at the second frequency between a second short wavelength and a second long wavelength,
the second long wavelength is longer than the second short wavelength,
the second short wavelength is longer than the first long wavelength, or the second long wavelength is shorter than the first short wavelength.

### Technical Proposal 3

The gas detection device according to Technical proposal 1, wherein
the driver section includes:
   a signal generator configured to output a base signal having a base frequency,
   a first multiplier configured to supply a first signal having a frequency being a first integer multiple of the base frequency to the first driver based on the base signal,
   a second multiplier configured to supply a second signal having a frequency being a second integer multiple of the base frequency to the second driver based on the base signal, and
the second integer is different from the first integer.

### Technical Proposal 4

The gas detection device according to Technical proposal 3, wherein
the first integer is 3, and
the second integer is 4.

### Technical Proposal 5

The gas detection device according to any one of Technical proposals 1-4, wherein
the second frequency is different from an integer multiple of twice the first frequency, and
the first frequency is different from an integer multiple of twice the second frequency.

### Technical Proposal 6

The gas detection device according to any one of Technical proposals 1-5, wherein
the first beam and the second beam include near-infrared rays, middle-infrared rays, or far-infrared rays.

### Technical Proposal 7

The gas detection device according to any one of Technical proposals 1-6, wherein
the first wavelength is not less than 4.4 μm and not more than 4.7 μm, and
the second wavelength is not less than 7.6 μm and not more than 7.9 μm.

### Technical Proposal 8

The gas detection device according to any one of Technical proposals 1-7, wherein
a first intensity of the output signal in a first state is lower than a second intensity of the output signal in a second state, and
a concentration of a first detection target present on a path of the first beam in the first state is higher than a second concentration of the first detection target present on the path in the second state.

### Technical Proposal 9

The gas detection device according to Technical proposal 1, wherein
the detector is configured to extract a first component of the output signal at a frequency twice the first frequency, and
the detector is configured to extract a second component of the output signal at a frequency twice the second frequency.

### Technical Proposal 10

The gas detection device according to Technical proposal 9, wherein
the first component changes depending on a state of the first detection target present on a first path of the first beam, and
the second component changes depending on a state of the second detection target present on a second path of the second beam.

### Technical Proposal 11

The gas detection device according to any one of Technical proposals 1-10, wherein
at least a part of a second period in which the second beam is emitted overlaps a first period in which the first beam is emitted.

### Technical Proposal 12

The gas detection device according to any one of Technical proposals 1-11, wherein
at least a part of the second beam spatially overlaps the first beam.

### Technical Proposal 13

The gas detection device according to any one of Technical proposals 1-12, further comprising:
a first optical element configured to overlap the second beam with the first beam.

### Technical Proposal 14

The gas detection device according to any one of Technical proposals 1-13, wherein
the received beam includes reflected beams of the first beam and the second beam.

### Technical Proposal 15

The gas detection device according to Technical proposal 9, wherein
the driver section further includes a third driver,
the element section further includes a third laser,
the third laser is configured to be driven by the third driver to emit a third beam,
a third wavelength of the third beam is configured to change at a third frequency,
the third wavelength is different from the first wavelength and different from the second wavelength,
the third frequency is different from the first frequency and different from the second frequency,
the received beam is further based on the third beam, and
the detector is configured to further extract a third component of the output signal at a frequency twice the third frequency.

### Technical Proposal 16

The gas detection device according to Technical proposal 15, wherein
the driver section includes:
a signal generator configured to output a base signal having a base frequency,
a first multiplier configured to supply a first signal having a frequency being a first integer multiple of the base frequency to the first driver based on the base signal,
a second multiplier configured to supply a second signal having a frequency being a second integer multiple of the base frequency to the second driver based on the base signal, and
a third multiplier configured to supply a third signal having a frequency being a third integer multiple of the base frequency to the third driver based on the base signal,
the second integer is different from the first integer,
the third integer is different from the first integer and different from the second integer,
the first driver is configured to supply a first drive signal based on the first signal to the first laser,
the second driver is configured to supply a second drive signal based on the second signal to the second laser, and
the third driver is configured to supplies a third drive signal based on the third signal to the third laser.

### Technical Proposal 17

The gas detection device according to Technical proposal 16, wherein
the first integer is 3,
the second integer is 4, and
the third integer is a prime number greater than or equal to 5.

### Technical Proposal 18

The gas detection device according to Technical proposal 16, wherein
the driver section further includes a fourth driver,
the element section further includes a fourth laser,
the fourth laser is configured to be driven by the fourth driver to emit a fourth beam,
a fourth wavelength of the fourth beam is configured to change at a fourth frequency,
the fourth wavelength is different from the first wavelength, different from the second wavelength, and different from the third wavelength,
the fourth frequency is different from the first frequency, different from the second frequency, and different from the third frequency,
the received beam is further based on the fourth beam, and
the detector is configured to further extract a fourth component of the output signal at a frequency twice the fourth frequency.

### Technical Proposal 19

The gas detection device according to Technical proposal 18, wherein
the driver section further includes a fourth multiplier,
the fourth multiplier is configured to supply a fourth signal having a frequency being a fourth integer multiple of the base frequency to the fourth driver based on the base signal, and
the fourth integer is different from the first integer, different from the second integer, and different from the third integer.

### Technical Proposal 20

A control method of a gas detection device according to Technical proposal 9, the method comprising:
causing the gas detection device to execute a first operation of outputting a value corresponding to a ratio of a second intensity of a component of the output signal having a frequency twice the first frequency to the first intensity, when the first intensity of the component of the output signal having the first frequency is higher than a first reference value, and
causing the gas detection device not to execute the first operation when the first intensity is equal to or less than the first reference value.

According to the embodiment, it is possible to provide a gas detection device that can be miniaturized and a method for controlling the gas detection device.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in gas detection devices such driver sections, element sections, lasers, drivers, multipliers, sensors, and detectors, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all gas detection devices and the methods for controlling the gas detection devices practicable by an appropriate design modification by one skilled in the art based on the gas detection devices and the methods for controlling the gas detection devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A gas detection device, comprising:
a driver section including a first driver and a second driver;
an element section including a first laser and a second laser, the first laser being configured to be driven by the first driver to emit a first beam, a first wavelength of the first beam being configured to change at a first frequency, the second laser being configured to be driven by the second driver to emit a second beam, a second wavelength of the second beam being configured to change at a second frequency, the second frequency being different from the first beam, the second wavelength being different from the first wavelength;
a sensor configured to detect a received beam based on the first beam and the second beam; and
a detector configured to extract a target frequency component from an output signal from the sensor.

2. The gas detection device according to claim 1, wherein
the first wavelength is configured to change at the first frequency between a first short wavelength and a first long wavelength,
the first long wavelength is longer than the first short wavelength,
the second wavelength is configured to change at the second frequency between a second short wavelength and a second long wavelength,
the second long wavelength is longer than the second short wavelength,
the second short wavelength is longer than the first long wavelength, or the second long wavelength is shorter than the first short wavelength.

3. The gas detection device according to claim 1, wherein
the driver section includes:
a signal generator configured to output a base signal having a base frequency,
a first multiplier configured to supply a first signal having a frequency being a first integer multiple of the base frequency to the first driver based on the base signal,
a second multiplier configured to supply a second signal having a frequency being a second integer multiple of the base frequency to the second driver based on the base signal, and
the second integer is different from the first integer.

4. The gas detection device according to claim 3, wherein
the first integer is 3, and
the second integer is 4.

5. The gas detection device according to claim 1, wherein
the second frequency is different from an integer multiple of twice the first frequency, and
the first frequency is different from an integer multiple of twice the second frequency.

6. The gas detection device according to claim 1, wherein
the first beam and the second beam include near-infrared rays, middle-infrared rays, or far-infrared rays.

7. The gas detection device according to claim 1, wherein
the first wavelength is not less than 4.4 μm and not more than 4.7 μm, and
the second wavelength is not less than 7.6 μm and not more than 7.9 μm.

8. The gas detection device according to claim 1, wherein
a first intensity of the output signal in a first state is lower than a second intensity of the output signal in a second state, and
a concentration of a first detection target present on a path of the first beam in the first state is higher than a second concentration of the first detection target present on the path in the second state.

9. The gas detection device according to claim 1, wherein
the detector is configured to extract a first component of the output signal at a frequency twice the first frequency, and
the detector is configured to extract a second component of the output signal at a frequency twice the second frequency.

10. The gas detection device according to claim 9, wherein
the first component changes depending on a state of the first detection target present on a first path of the first beam, and
the second component changes depending on a state of the second detection target present on a second path of the second beam.

11. The gas detection device according to claim 1, wherein
at least a part of a second period in which the second beam is emitted overlaps a first period in which the first beam is emitted.

12. The gas detection device according to claim 1, wherein
at least a part of the second beam spatially overlaps the first beam.

13. The gas detection device according to claim 1, further comprising:
a first optical element configured to overlap the second beam with the first beam.

14. The gas detection device according to claim 1, wherein
the received beam includes reflected beams of the first beam and the second beam.

15. The gas detection device according to claim 9, wherein
the driver section further includes a third driver,
the element section further includes a third laser,
the third laser is configured to be driven by the third driver to emit a third beam,
a third wavelength of the third beam is configured to change at a third frequency,
the third wavelength is different from the first wavelength and different from the second wavelength,
the third frequency is different from the first frequency and different from the second frequency,
the received beam is further based on the third beam, and
the detector is configured to further extract a third component of the output signal at a frequency twice the third frequency.

16. The gas detection device according to claim 15, wherein
the driver section includes:
a signal generator configured to output a base signal having a base frequency,
a first multiplier configured to supply a first signal having a frequency being a first integer multiple of the base frequency to the first driver based on the base signal,
a second multiplier configured to supply a second signal having a frequency being a second integer multiple of the base frequency to the second driver based on the base signal, and
a third multiplier configured to supply a third signal having a frequency being a third integer multiple of the base frequency to the third driver based on the base signal,
the second integer is different from the first integer,
the third integer is different from the first integer and different from the second integer,
the first driver is configured to supply a first drive signal based on the first signal to the first laser,
the second driver is configured to supply a second drive signal based on the second signal to the second laser, and
the third driver is configured to supplies a third drive signal based on the third signal to the third laser.

17. The gas detection device according to claim 16, wherein
the first integer is 3,
the second integer is 4, and
the third integer is a prime number greater than or equal to 5.

18. The gas detection device according to claim 16, wherein
the driver section further includes a fourth driver,
the element section further includes a fourth laser,
the fourth laser is configured to be driven by the fourth driver to emit a fourth beam,
a fourth wavelength of the fourth beam is configured to change at a fourth frequency,
the fourth wavelength is different from the first wavelength, different from the second wavelength, and different from the third wavelength,
the fourth frequency is different from the first frequency, different from the second frequency, and different from the third frequency,
the received beam is further based on the fourth beam, and
the detector is configured to further extract a fourth component of the output signal at a frequency twice the fourth frequency.

19. The gas detection device according to claim 18, wherein
the driver section further includes a fourth multiplier,
the fourth multiplier is configured to supply a fourth signal having a frequency being a fourth integer multiple of the base frequency to the fourth driver based on the base signal, and
the fourth integer is different from the first integer, different from the second integer, and different from the third integer.

20. A control method of the gas detection device according to claim 9, the method comprising:
causing the gas detection device to execute a first operation of outputting a value corresponding to a ratio of a second intensity of a component of the output signal having a frequency twice the first frequency to the first intensity, when the first intensity of the component of the output signal having the first frequency is higher than a first reference value, and
causing the gas detection device not to execute the first operation when the first intensity is equal to or less than the first reference value.
